(19) United States
(12) Patent Application Publication
(10) Pub. No.: US 2008/0299973 A1
(43) Pub. Date: Dec. 4, 2008

(54) METHOD AND APPARATUS FOR SUPPORTING A CONTROLLED HANDOVER IN A WIRELESS NETWORK

(75) Inventor: Shahab M. Sayeedi, Naperville, IL (US)

Correspondence Address: MOTOROLA, INC., 1303 EAST ALGONQUIN ROAD, IL01/3RD, SCHAUMBURG, IL, 60196, US

(73) Assignee: Motorola, Inc., Schaumburg, IL (US)

(21) Appl. No.: 12/121,839

(22) Filed: May 16, 2008

Related U.S. Application Data
(60) Provisional application No. 60/940,541, filed on May 29, 2007.

(51) Int. Cl. H04Q 7/20; H04M 1/00

(52) U.S. Cl. 455/436; 455/561

(57) ABSTRACT

Various embodiments are described to reduce latency delays and/or adverse impacts to real-time applications when a remote unit (101) is unable to handover to any of the network nodes offered as handover candidates by the serving network node (121). In response to receiving a first message that includes an indication of one or more network nodes offered as handover candidates, the remote unit sends a second message that is of a type used to reject handover candidate nodes. In this second message, the remote unit includes an indication of one or more requested network nodes to which it requests to handover. By indicating network nodes that were not offered as handover candidates in the first message along with the rejection of those candidates, the network does not have to determine another group of candidates for the remote unit. Rather, it can proceed by considering the requested nodes for approval.

### REFERENCE(S) TO RELATED APPLICATION(S)

The present application claims priority from a provisional application, Ser. No. 60/940,541, entitled “METHOD AND APPARATUS FOR SUPPORTING A CONTROLLED HANDOVER IN A WIRELESS NETWORK,” filed May 29, 2007, which is commonly owned and incorporated herein by reference in its entirety.

### FIELD OF THE INVENTION

The present invention relates generally to communication systems and, in particular, to supporting a controlled handover in a wireless network.

### BACKGROUND OF THE INVENTION

Uncontrolled or unsolicited handovers in WiMAX and 802.16e-2004 based networks refer to a handover scenario where a mobile station (MS) autonomously initiates a handover request at a target base station (BS) without prior notification to its current serving BS that it intends to handover to another BS. Unsolicited handovers are inefficient because the target BS is not informed of the impending handover from the MS by the MS's previous serving BS and therefore is unable to prepare and allocate air interface and network resources in advance of the MS arriving. This can result in latency delays which may be detrimental to real-time applications. Worse, the MS may not have the resources required to support the MS after a handover and must reject the MS after it initiates the hand-in, possibly resulting in a dropped call.

Controlled handovers in WiMAX and 802.16-2005 based networks may be initiated by either an MS or a current serving BS/Access Service Network (ASN). See 802.16e-2005 (including Corrigendum 1) section 6.3.22.2 and WiMAX End-to_end Networking Systems Architecture Stage-3 Text (Aug. 8, 2006 Release 1 V&V DRAFT), Section 5.7.2. Such controlled handovers may be initiated in response to issues related to RF conditions, network load or capacity, maintenance, etc.

An 802.16e compliant MS may initiate a controlled handover request from the serving BS/ASN by sending a MOB_MSHO-REQ message which may include one or more potential target BSs selected by the MS based on prior scanning of neighbor cells to the current serving BS. See 802.16e-2005 Section 6.3.22.2.2. The serving BS responds by sending a MOB_BSHO-RSP message to the MS which includes one or more candidate target BSs selected by the ASN that the MS may handover to. The candidate target cells offered by the network may or may not include target cells selected by the MS based on network or ‘backbone’ signaling between the serving BS/ASN and potential target BS(s)/ASN(s) used to determine whether potential target cells are willing to accept a handover from the MS.

The MS's current serving BS/ASN may also initiate a handover on behalf of the MS (network initiated handover) by sending the MS a MOB_BSHO-REQ message and may include one or more candidate target BSs for the MS to consider handover to. See 802.16e-2005 Section 6.3.22.2.2. Regardless of whether the controlled handover is initiated by the MS or network (via MOB_MSHO-REQ or MOB_BSHO-REQ messages respectively), the MS may reject the candidate target BSs offered to it by the serving network by sending a MOB_HO-IND message to the serving BS with the HO_IND_type TLV field in the message set to handover reject). See 802.16e-2005 Section 6.3.2.3.55.

An MS may reject target BS(s) offered to it for handover by the serving BS/ASN due to weak scanning results for the target BS and/or changing RF conditions whereby the candidate target BS is no longer a viable candidate for supporting a handover from the mobile due to rapidly changing RF conditions, which are common in wireless mobile networks. An MS may further chose to reject a candidate target BS offered by the serving BS/ASN based on information it has gained about the target BS through decoding of downlink transmission from the target BS.

Regardless why an MS chooses to reject a recommended target candidate BS(s), offered by the serving BS/ASN, the network must provide an alternate target BS for the MS to handover to before either RF conditions at the serving cell deteriorate further and the call is dropped or before the MS is forced to perform an unsolicited handover to a target BS (which will very likely result in latency delays and/or a dropped call, both being undesirable outcomes from a user perspective).

If an 802.16e-based MS rejects the target BS(s) offered for handover by the serving BS/ASN, the MS starts timer T42 and goes to the MS HO holding down state waiting for alternate target cells from the network. See 802.16e-2005 FIG. 130f. In order to identify an alternate target for the MS to handover to, one of the following actions is available to the MS or the network.

First, MS sets 802.16e timer T42 and waits in the MS HO holding down state until the BS sends alternative target BS(s) in the MOB_BSHO-RSP (if MS initiated handover) or MOB_BSHO-REQ (if network initiated handover) message. If the serving BS/ASN does not provide an alternate target BS prior to expiration of the T42 timer, the MS will restart the controlled handover procedure or perform an uncontrolled handover. See 802.16e-2005 FIG. 130f. The serving network can obtain expected MS performance at alternate target BS(s) by performing backbone signaling in the network with the possible target BS(s)/ASN(s) or by using information based on previous scanning measurements from the MS. See 802.16e-2005 6.3.22.2.2. The serving network then re-sends a MOB_BSHO-RSP (MS initiated HO) or MOB_BSHO-REQ (network initiated handover) message with alternate target BS(s) to the MS. Signaling flow diagram 400, in FIG. 4, depicts, as an example, a MOB_BSHO-RSP message being resent after the MS rejects the target BS(s) offered for handover.

Network ‘backbone’ signaling support to determine target BS reception of MS is not currently supported in WiMAX networks. Assuming it is added in the future and a vendor supports such procedures, latency delays associated with this method may be substantial, since they may be driven by the time required for potential target BS(s) to complete RF measurements and forward results via network backbone signaling to the serving BS/ASN. In addition, if RF conditions change from the MS's perspective, alternate handover target BS(s) measurements may again be ‘stale’ at the serving BS and then rejected by the MS. T42 timer setting (operator configured) must be long enough for the network backbone signaling to complete. If T42 expires, an uncontrolled handover may occur, adding further latency delays (e.g., signaling 4-6 in diagram 400, FIG. 4).

Second, upon transmission of MOB-HO_IND message rejecting handover target BS(s) offered by serving network, MS exits MS HO holding down state and sends or re-sends MOB_MSHO-REQ message containing new potential target BS(s) the MS is able to handover to. Signaling flow diagram 500, in FIG. 5, depicts, as an example, a MOB_MSHO-REQ message being resent after the MS rejects the target BS(s) offered for handover. By starting or restarting MS initiated handover signaling procedures with the network, latency delays are incurred (e.g., signaling 5-8 in diagram 500).

Third, if periodic scan reporting was previously configured by the serving BS, the network waits for a MOB_SCN-REP message from the MS containing the latest scanning results for neighbor BSs. See 802.16e-2005 section 6.3.2.3.50. The delay period associated with this method is based on how many frames the MS must scan for each measurement for neighbor cells, how often the MS is configured to report its measurements, and the signaling period needed to send this message after the MOB_HO-IND. These parameters are specified in the MOB_SCN-REP by the 802.16e Scan duration (no. of frames) and Report period (no. of frames) parameters respectively.

Fourth, the network requests an event triggered scanning report by sending a MOB_SCN-RSP message to the MS and waits for the MOB_SCN-REP containing latest scanning results for neighbor BSs. See 802.16e-2005 section 6.3.2.3.50. The delay period associated with this method is based on how many frames the MS must scan for each measurement for neighbor cells as specified by the 802.16e Scan duration parameter before reporting to the serving BS, and the signaling period needed to send this message after the MOB_HO-IND.

Signaling flow diagram 600, in FIG. 6, depicts, as an example, an MS initiated controlled handover procedure using either the third or fourth options described immediately above. Handover latency delays may be incurred for signaling 4, 5, 6, 8 and 9 in diagram 600.

All four of the options described above require additional time to perform signaling over the air and/or in the backbone network to find an alternate target BS(s) to offer the mobile for handover. However, in view of the state of the art in this area, new techniques able to reduce or minimize the time required to offer an alternate target BS for an MS handover are clearly desirable for advancing the art.

### BRIEF DESCRIPTION OF THE DRAWINGS

FIG. 1 is a block diagram depiction of a wireless communication system in accordance with multiple embodiments of the present invention.

FIG. 2 is a signaling flow diagram that depicts a mobile initiated controlled handover, in accordance with multiple embodiments of the present invention.

FIG. 3 is a signaling flow diagram that depicts a network initiated controlled handover, in accordance with multiple embodiments of the present invention.

FIG. 4 is a signaling flow diagram that depicts a mobile initiated handover, in accordance with the prior art.

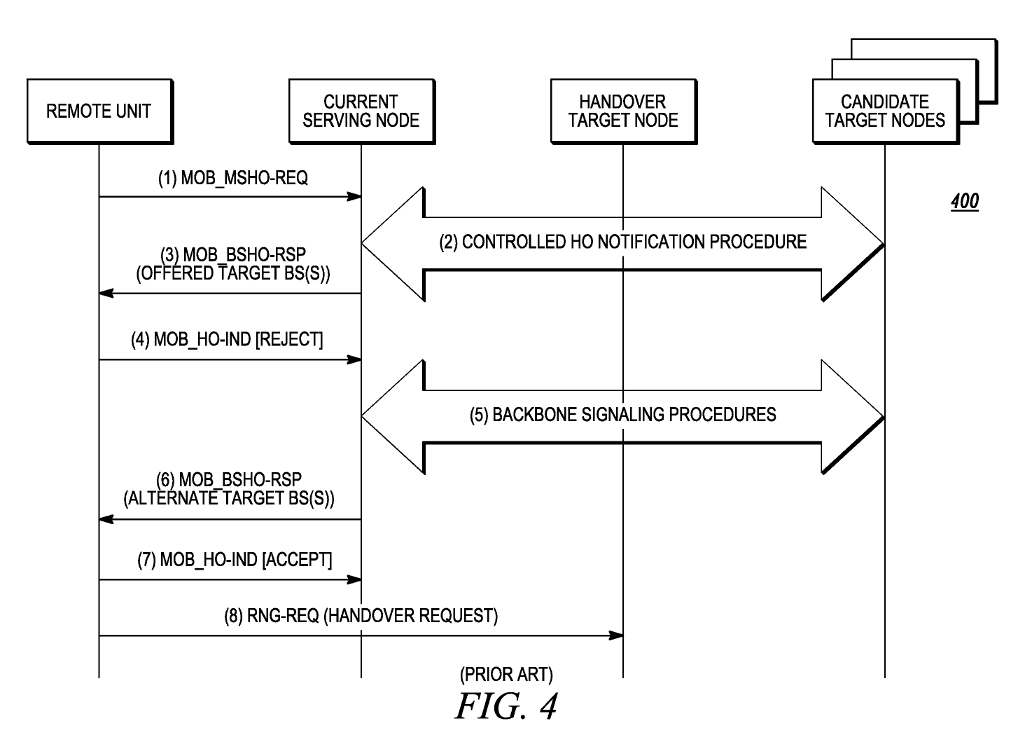

FIG. 5 is a signaling flow diagram that depicts a mobile initiated handover, in accordance with the prior art.

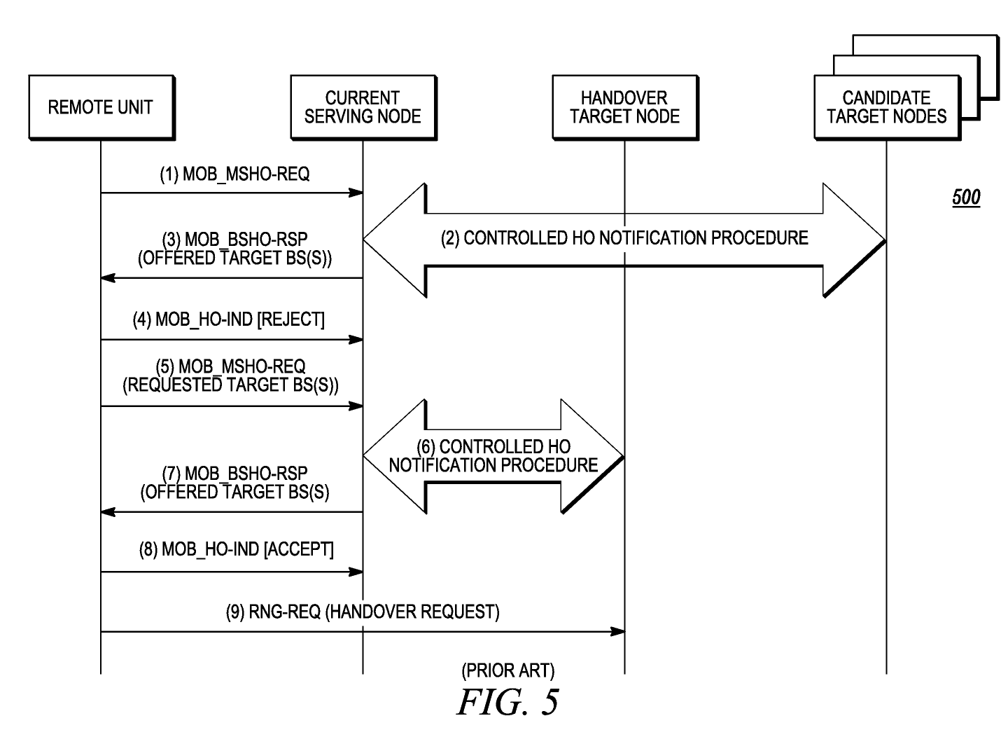

FIG. 6 is a signaling flow diagram that depicts a mobile initiated handover, in accordance with the prior art.

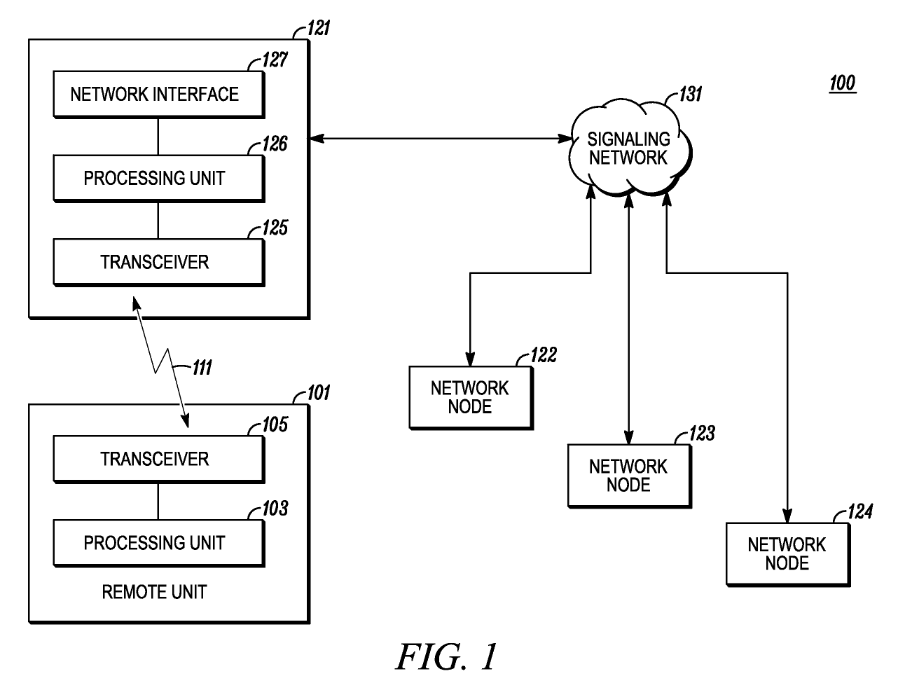

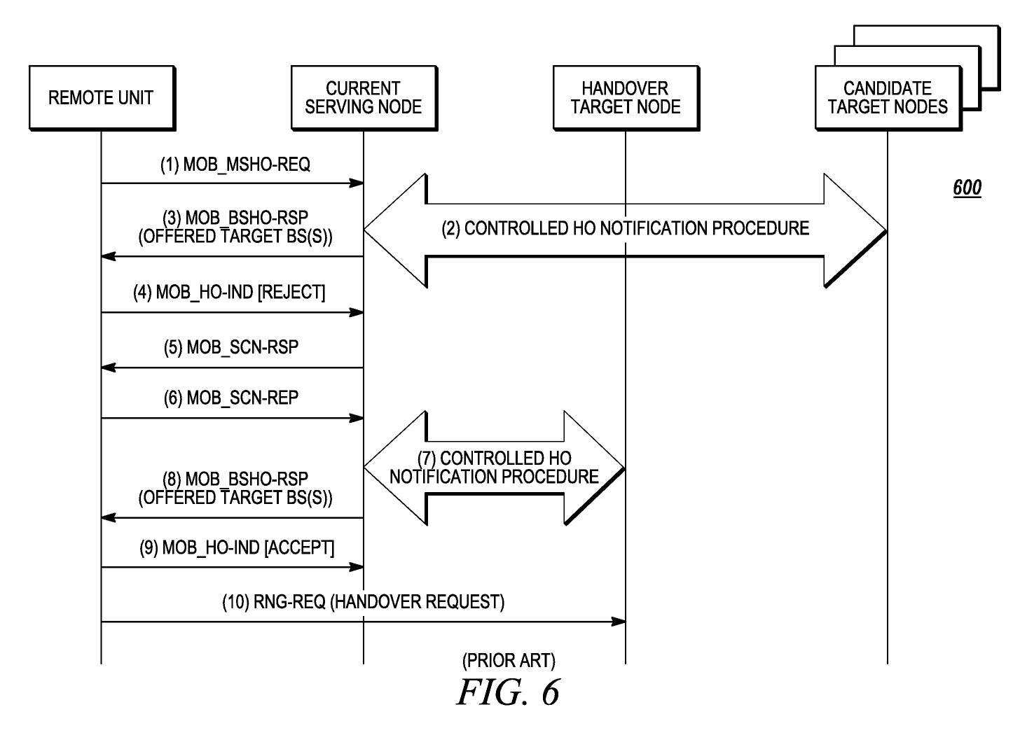

Specific embodiments of the present invention are disclosed below with reference to FIGS. 1-3. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the signaling flow diagrams and/or the logic flow diagrams above are described and shown with reference to specific signaling exchanged and/or specific functionality performed in a specific order, some of the signaling/functionality may be omitted or some of the signaling/functionality may be combined, sub-divided, or reordered without departing from the scope of the claims. Thus, unless specifically indicated, the order and grouping of the signaling/functionality depicted is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### DETAILED DESCRIPTION OF EMBODIMENTS

Various embodiments are described to reduce latency delays and/or adverse impacts to real-time applications when a remote unit is unable to handover to any of the network nodes offered as handover candidates by the serving network node. In response to receiving a first message that includes an indication of one or more network nodes offered as handover candidates, the remote unit sends a second message that is of a type used to reject handover candidate nodes. In this second message, the remote unit includes an indication of one or more requested network nodes to which it requests to handover. By indicating network nodes that were not offered as handover candidates in the first message along with the rejection of those candidates, the network does not have to determine another group of candidates for the remote unit. Rather, it can proceed by considering the requested nodes for approval.

The disclosed embodiments can be more fully understood with reference to FIGS. 1-3. FIG. 1 is a block diagram depiction of a wireless communication system 100 in accordance with multiple embodiments of the present invention. At present, standards bodies such as OMA (Open Mobile Alliance), 3GPP (3rd Generation Partnership Project), 3GPP2 (3rd Generation Partnership Project 2), IEEE (Institute of Electrical and Electronics Engineers) 802, and WiMAX Forum are developing standards specifications for wireless telecommunications systems. (These groups may be contacted via http://www.openmobilealliance.com, http://www.3gpp.org/, http://www.3gpp2.com/, http://www.ieee802.org/, and http://www.wimaxforum.org/ respectively.) Communication system 100 represents a system having an architecture in accordance with one or more of the WiMAX Forum and/or IEEE 802 technologies, suitably modified to implement the present invention. Alternative embodiments of the present invention may be implemented in communication systems that employ other or additional technologies such as, but not limited to, those described in the OMA, 3GPP, and/or 3GPP2 specifications.

Communication system 100 is depicted in a very generalized manner. For example, system 100 is shown to simply include remote unit 101, network nodes 121-124 and signaling network 131. Network nodes 121-124 are shown having interconnectivity via signaling network 131. Network node 121 is shown providing network service to remote unit 101 using wireless interface 111. The wireless interface used is in accordance with the particular access technology supported by network node 121, such as one based on IEEE 802.16. Network nodes 121-124 may all utilize the same wireless access technology, or they may utilize different access technologies. Those skilled in the art will recognize that FIG. 1 does not depict all of the physical fixed network components that may be necessary for system 100 to operate but only those system components and logical entities particularly relevant to the description of embodiments herein.

For example, FIG. 1 does not depict that network nodes 122-124 each comprise processing units, network interfaces and transceivers. In general, components such as processing units, transceivers and network interfaces are well-known. For example, processing units are known to comprise basic components such as, but neither limited to nor necessarily requiring, microprocessors, microcontrollers, memory devices, application-specific integrated circuits (ASICs), and/or logic circuitry. Such components are typically adapted to implement algorithms and/or protocols that have been expressed using high-level design languages or descriptions, expressed using computer instructions, expressed using signaling flow diagrams, and/or expressed using logic flow diagrams.

Thus, given a high-level description, an algorithm, a logic flow, a messaging/signaling flow, and/or a protocol specification, those skilled in the art are aware of the many design and development techniques available to implement a processing unit that performs the given logic. Therefore, devices 121-124 represent known devices that have been adapted, in accordance with the description herein, to implement multiple embodiments of the present invention. Furthermore, those skilled in the art will recognize that aspects of the present invention may be implemented in or across various physical components and none are necessarily limited to single platform implementations. For example, a network node may be implemented in or across one or more RAN components, such as a base transceiver station (BTS) and/or a base station controller (BSC), a Node-B and/or a radio network controller (RNC), or an HRPD AN and/or PCF, or implemented in or across one or more access network (AN) components, such as an access service network (ASN) gateway and/or ASN base station (BS), an access point (AP), a wideband base station (WBS), and/or a WLAN (wireless local area network) station.

Remote unit 101 and network node 121 are shown communicating via technology-dependent, wireless interface 111. Remote units, subscriber stations (SSs) and/or user equipment (UEs), may be thought of as mobile stations (MSs), mobile subscriber stations (MSSs), mobile devices or mobile nodes (MNs). In addition, remote unit platforms are known to refer to a wide variety of consumer electronic platforms such as, but not limited to, mobile stations (MSs), access terminals (ATs), terminal equipment, mobile devices, gaming devices, personal computers, and personal digital assistants (PDAs). In particular, remote unit 101 comprises a processing unit (103) and transceiver (105). Depending on the embodiment, remote unit 101 may additionally comprise a keypad (not shown), a speaker (not shown), a microphone (not shown), and a display (not shown). Processing units, transceivers, keypads, speakers, microphones, and displays as used in remote units are all well-known in the art.

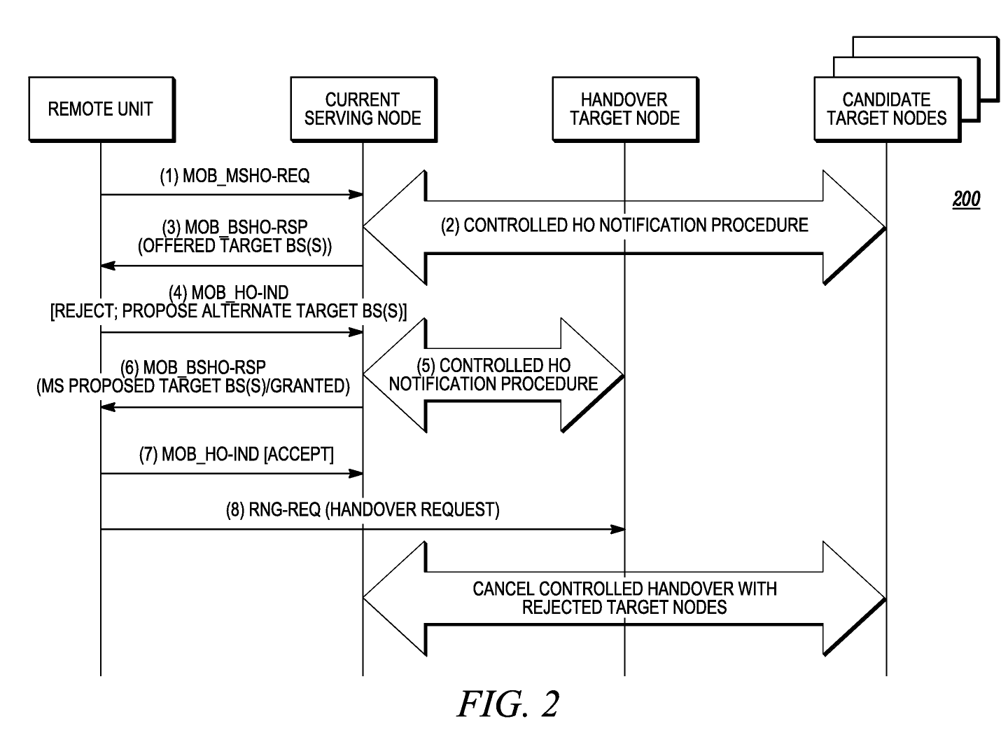

Operation of embodiments in accordance with the present invention occurs substantially as follows, first with reference to FIG. 1. As depicted in FIG. 1, network node 121 is the current serving node for remote unit 101. A handover may be initiated by either remote unit 101 or network node 121. If processing unit 103 determines that a handover is desirable, it may send a request for a handover to network node 121 via transceiver 105. Depending on the embodiment and the wireless interface that the remote unit and network node are using, the remote unit may send a handover request message, such as an IEEE 802.16e-2005 MOB_MSHO-REQ message, to request a handover. For example, signaling flow diagram 200, in FIG. 2, depicts a mobile initiated controlled handover in which a MOB_MSHO-REQ message is sent by the remote unit and may include suggested target network nodes to handover to.

In the case of a mobile initiated handover, processing unit 126 responds by sending a message that includes an indication of one or more network nodes offered as handover candidates to remote unit 101. In an IEEE 802.16e-2005 embodiment, a MOB_BSHO-RSP message may be sent offering network nodes 122 and 123 (chosen purely for the sake of illustration) as handover candidates for remote unit 101. Diagram 200 provides an example of a MOB_BSHO-RSP message being sent to the remote unit.

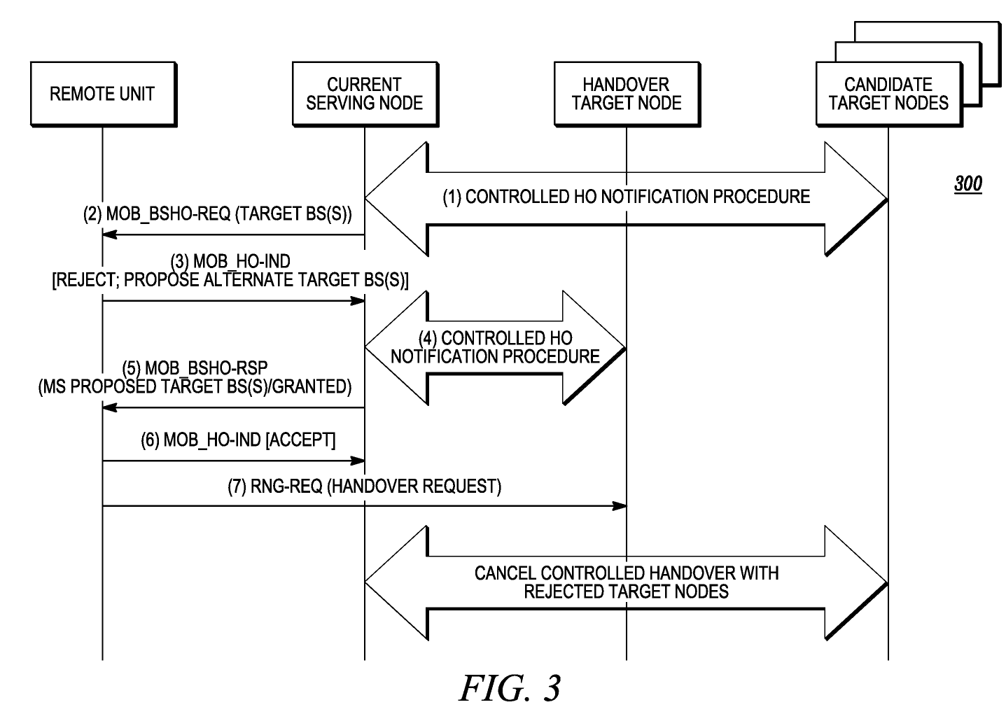

However, in the case of a network initiated handover, processing unit 126, rather than responding to a handover request from the remote unit, sends a message, to initiate a handover, that includes an indication of one or more network nodes offered as handover candidates to remote unit 101. In an IEEE 802.16 embodiment, network node 121 sends a MOB_BSHO-REQ message offering network nodes 122 and 123 (chosen purely for the sake of illustration) as handover candidates for remote unit 101. For example, signaling flow diagram 300, in FIG. 3, depicts a network initiated controlled handover in which a MOB_BSHO-REQ message is sent by the serving node.

In both cases, whether network initiated or mobile initiated, the network has offered network nodes 122 and 123 (chosen purely for the sake of the present illustration) as handover candidates for remote unit 101. However, for one of a variety of reasons depending on the situation at hand and/or the embodiment, none of the handover candidates offered are acceptable to remote unit 101. As such, processing unit 103 responds with a message that that is used to reject handover to network nodes offered as handover candidates. In addition, this message includes an indication of a requested network node (such as network node 124 for the present illustration) to which remote unit 101 requests to handover. Processing unit 103 may use a handover indication message, such as an IEEE 802.16e-2005 MOB_HO-IND message, to reject the handover candidates offered and to additionally indicate one or more network nodes that would be acceptable handover targets. Both diagrams 200 and 300 provide examples of the remote unit using a MOB_HO-IND message.

Depending on the embodiment, the handover indication message may include a field in which the requested network node(s) is identified. The following is a very detailed example of a message format for an IEEE 802.16 MOB_HO-IND message that the remote unit could use to indicate requested network nodes (Target_BS_IDs, e.g.) as alternates to the handover candidates being rejected:

MOB_HO-IND message format:

Syntax Size Notes
MOB_HO-IND_Message_format( ) { --
Management Message Type = 59 8 bits -
Reserved 6 bits Reserved; shall be set to zero
Mode 2 bits 0b00: HO
0b01: MDHO/FBSS: Anchor BS update
0b10: MDHO/FBSS: Diversity Set update
0b11: Reserved
if (Mode == 0b00) { --
HO_IND_type 2 bits 0b00: serving BS release
0b01: HO cancel
0b10: HO reject
0b11: Reserved
Ranging_Params_valid_indication 2 bits 0b00: No indication.
BS ignores this field
(Default)
0b01: MS ranging parameters for Target BS,
which is specified in this message are valid
0b10: MS has no valid ranging parameters for
Target BS, which is specified in this message
0b11: Reserved
Reserved 4 bits Shall be set to zero.
if (HO_IND_type == 0b00) { --
Target_BS_ID 48 bits Applicable only when HO_IND_type is set to
0b00 or 0b10.
} --
} --

MOB_HO-IND Message Use Description:

If the MS signals rejection of serving BS instruction to HO (handover) through HO_IND_type field in the MOB_HO-IND set value of 0b10 (HO reject option), the BS may reconfigure the neighbor BS list and retransmit MOB_BSHO-RSP message including a new neighbor BS list. If the MS signals rejection of handover to the target BSs proposed by the serving BS or network in the MOB_BSHO-REQ or MOB_BSHO-RSP messages (MS initiated or Network initiated handover respectively) by sending a MOB_HO-IND message with the HO_IND_type TLV set to 0b10 (HO reject option), the MS may include one or more alternate preferred target BS(s) in the MOB_HO-IND message for the serving BS to consider. If the serving BS or network reconfigures the neighbor BS list to retransmit the MOB_BSHO-REQ or MOB_BSHO-RSP message, it may include the MS preferred target BS conveyed if conveyed in the MOB_HO-IND message.

Upon receiving a handover indication message rejecting nodes 122 and 123 and providing node 124 as an alternate, network node 121 determines whether node 124 is acceptable and, if so, indicates that the requested network node is approved as a handover target for remote unit 101 (node 121 may do this by offering node 124 as a target node to remote unit 101). In an IEEE 802.16 embodiment, a MOB_BSHO-RSP message (or possibly a MOB_BSHO-REQ message) may be sent with network node 124 included as the proposed target network node for remote unit 101 to handover to. The message that is sent may either identify the approved node(s) explicitly or indicate that the one(s) requested by the remote unit are approved.

Network node 121 may also send a message to requested network node 124 that includes an indication that a handover of remote unit 101 to node 124 may occur. In addition, network node 121 may send a message to node 122 and 123 that includes an indication that a potential handover of remote unit 101 is canceled. Diagrams 200 and 300 provide examples of this type of controlled handover notification signaling between the current serving node and the potential handover target nodes.

Repeated reference has been made to IEEE 802.16e-2005 embodiments throughout. A brief summary that focuses on certain IEEE 802.16 embodiments appears below to provide some additional, and more particular examples. They are intended to further the reader's understanding of the variety of possible embodiments rather than to limit the scope of the invention.

If an MS decides to reject target BS candidate(s) offered by a Serving BS/ASN to the MS in the MOB_BSHO-RSP (mobile initiated handover) or MOB_BSHO-REQ (network initiated handover) message, the MS may include an alternate handover target BS(s) (based on its most recent scanning of neighbors, e.g.) in the MOB_HO-IND message sent to the serving BS/ASN to indicate rejection of the candidate target BS(s) previously offered to it. Alternate handover target BS(s) are ‘piggybacked’ on to an existing rejection message (i.e., the MOB_HO-IND message) to reduce signaling latency delays introduced in prior art methods. Furthermore, since the Serving BS/ASN is expecting an MOB_HO-IND message from the MS, there is minimal impact to MS and network state machines to implement this additional signaling information as opposed to adding new signaling messages to convey preferred target BS.

The network immediately prepares one of the proposed target BSs sent to it by the MS and grants the target BS requested by the MS by resending the MOB_BSHO-REQ or MOB_BSHO-RSP message with an indication that the target BS requested by the MS is granted. The MS then resends the MOB_HO-IND message to the serving BS/ASN, this time accepting the candidate target BS offered to the MS, then proceeds to begin ranging (request a handover) at the new target BS which was notified and is expecting the MS as a controlled handover. As described here, there is minimal impact to existing MS and BS state machine tables and implementation since the modified rejection message carrying the new target BS requested by the MS is part of the existing signaling protocol.

By making use of a message used to reject a handover order sent by the MS to convey new potential target BS(s) to the serving BS/ASN, the additional time required to complete additional signaling required over the air and/or in the backbone network to find alternate target BS(s) for the MS to handover to is eliminated, thereby reducing the time required to complete a handover and the likelihood of dropped calls or unsolicited handovers from occurring.

One of skill in the art will appreciate that various modifications and changes may be made to the specific embodiments described above with respect to FIGS. 1-3 without departing from the spirit and scope of the present invention. Thus, the discussion of certain embodiments in greater detail above is to be regarded as illustrative and exemplary rather than restrictive or all-encompassing, and all such modifications to the specific embodiments described above are intended to be included within the scope of the present invention.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, and the like, are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the information or object being indicated. Some, but not all examples of techniques available for communicating or referencing the information or object being indicated include the conveyance of the information or object being indicated, the conveyance of an identifier of the information or object being indicated, the conveyance of information used to generate the information or object being indicated, the conveyance of some part or portion of the information or object being indicated, the conveyance of some derivation of the information or object being indicated, and the conveyance of some symbol representing the information or object being indicated. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

What is claimed is:

1. A method for supporting a controlled handover in a wireless network comprising:
receiving, by a remote unit from a serving network node, a first message that comprises an indication of at least one network node offered as a handover candidate;
sending, by the remote unit, a second message,
wherein the second message is used to reject handover to network nodes offered as handover candidates by the serving node,
wherein the second message comprises an indication of a requested network node to which the remote unit requests to handover, and
wherein the requested network node is not a network node indicated in the first message;
receiving, by the remote unit, a third message that comprises an indication that the requested network node is approved as a handover target for the remote unit.

2. The method of claim 1,
wherein the first message comprises one of a MOB_BSHO-REQ message and a MOB_BSHO-RSP message and
wherein the second message comprises a MOB_HO-IND message.

3. The method of claim 1, further comprising
sending, by the remote unit prior to receiving the first message, a request for a handover.

4. The method of claim 3, wherein sending the request for a handover comprises
sending a handover request message, wherein the first message comprises a handover response message.

5. The method of claim 1, wherein the first message comprises a handover request message.

6. The method of claim 1, wherein the second message comprises a handover indication message.

7. The method of claim 1, wherein the second message comprises a field in which the requested network node is identified.

8. A method for supporting a controlled handover in a wireless network comprising:
sending, to a remote unit, a first message that comprises an indication of at least one network node offered as a handover candidate;
receiving, from the remote unit, a second message,
wherein the second message is used to reject handover to network nodes offered as handover candidates,
wherein the second message comprises an indication of a requested network node to which the remote unit requests to handover, and
wherein the requested network node is not a network node indicated in the first message;
sending, to the remote unit, a third message that comprises an indication that the requested network node is approved as a handover target for the remote unit.

9. The method of claim 8,
wherein the first message comprises one of a MOB_BSHO-REQ message and a MOB_BSHO-RSP message and
wherein the second message comprises a MOB_HO-IND message.

10. The method of claim 8, further comprising
receiving, from the remote unit prior to sending the first message, a request to handover.

11. The method of claim 10,
wherein the request to handover comprises a handover request message and wherein the first message comprises a handover response message.

12. The method of claim 8, wherein the first message comprises a handover request message.

13. The method of claim 8, further comprising
sending a message to each of the at least one network node offered as a handover candidate that comprises an indication that a potential handover of the remote unit is canceled.

14. The method of claim 8, further comprising
sending, in response to receiving the second message, a message to the requested network node that comprises an indication that a handover of the remote unit to the requested network node may occur.

15. The method of claim 8, wherein the second message comprises a handover indication message.

16. The method of claim 8, wherein the second message comprises a field in which the requested network node is identified.

17. A remote unit comprising:
a transceiver;
a processing unit, communicatively coupled to the transceiver,
adapted to receive, from a serving network node via the transceiver, a first message that comprises an indication of at least one network node offered as a handover candidate,
adapted to send via the transceiver a second message, wherein the second message is used to reject handover to network nodes offered as handover candidates by the serving node, wherein the second message comprises an indication of a requested network node to which the remote unit requests to handover, and wherein the requested network node is not a network node indicated in the first message, and
adapted to receive via the transceiver a third message that comprises an indication that the requested network node is approved as a handover target for the remote unit.

18. A network node comprising:
a transceiver;
a network interface;
a processing unit, communicatively coupled to the transceiver and the network interface,
adapted to send, to a remote unit via the transceiver, a first message that comprises an indication of at least one network node offered as a handover candidate,
adapted to receive, from the remote unit via the transceiver, a second message, wherein the second message is used to reject handover to network nodes offered as handover candidates, wherein the second message comprises an indication of a requested network node to which the remote unit requests to handover, and wherein the requested network node is not a network node indicated in the first message, and
adapted to send, to the remote unit via the transceiver, a third message that comprises an indication that the requested network node is approved as a handover target for the remote unit.
